(19) United States
(12) Patent Application Publication
(10) Pub. No.: US 2005/0121852 A1
(43) Pub. Date: Jun. 9, 2005

(54) Method, apparatus and article for determining an initial hand in a playing card game, such as blackjack or baccarat

(75) Inventors: Richard Soltys, Newcastle, WA (US); Richard Huizinga, Newcastle, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Bally Gaming International, Inc., Las Vegas, NV (US)

(21) Appl. No.: 10/966,835

(22) Filed: Oct. 14, 2004

Related U.S. Application Data
(60) Provisional application No. 60/511,931, filed on Oct. 16, 2003.

(51) Int. Cl. A63F 1/12; A63F 1/14; A63F 13/00; A63F 9/24

(52) U.S. Cl. 273/149 P; 273/149 R; 463/9

(57) ABSTRACT

Methods and apparatus determine a value of an initial hand of playing cards, such as determining whether a dealer has the value of twenty-one, and/or outcome of a game at some point before the dealer receives a second card. The initial sequence may be read, optically, magnetically or wireless from identifiers on the playing cards, before the playing cards are loaded in a card shoe, while the playing cards reside in the card shoe, or as playing cards are removed from the card shoe. Alternatively, the initial sequence may correspond to a computationally generated sequence, such as a computationally pseudo-random sequence.

### BACKGROUND OF THE INVENTION

1. Field of the Invention

The present description generally relates to games employing playing cards, and in particular to the automation of certain aspects of card games, for example card games such as Blackjack or Baccarat.

2. Description of the Related Art

Card games are a well-known form of recreational entertainment. Games are typically played with one or more decks of playing cards, where each deck typically includes 52 playing cards of four suits (i.e., hearts, diamonds, clubs, and spades), each suit including 13 playing cards of varying rank (i.e., 2-10, Jack, Queen, King and Ace). Card games may, or may not, include wagering based on the game's outcome.

One popular card game, known as Blackjack, one or more players each compete against a dealer. The participants (i.e., players and dealer) attempt to collect a hand having a total point value equal to, or as close to twenty-one, without going over. The point value of the hand is determined by the rank of the playing card. Thus, playing cards having rank 2-10 have the point value 2-10, respectively. Face cards (i.e., Jack, Queen, King) have the point value 10, while Aces can have the point value 1 or 10 at the participant's discretion. An initial hand of two playing cards having a point value of twenty-one (i.e., an Ace plus a ten or a face card) is referred to as a natural “21”, or blackjack, and beats other hands with the point value of twenty-one.

In Blackjack, the dealer initially deals two playing cards to each of the participants in two passes around the table, starting with the participant at the dealer's far left (i.e., first base), extending through the participant at the dealer's far right (i.e., third base) and finally to the dealer's self. The players' cards are dealt face up in games where the playing cards are dealt from a shoe, and face down in hand-held games (i.e., games dealt by hand). The rules of play for the dealer are strictly dictated, leaving almost no decisions up to the dealer. Thus, the dealer, and other participants, can see the player's hands without affecting the outcome of the game.

The dealer turns over or is dealt one of the dealer's first two playing cards face up (i.e., top card), the rank of the playing card visible to the participants at the table. The dealer leaves or is dealt the second playing card face down (i.e., hole card), the rank of the playing card not visible to the participants at the table. In some variations of Blackjack, the dealer will immediately determine the point value of the hole card, while in other variations of the game the dealer waits until all players have played their hands before checking the point value of the hole card. Since a dealer's blackjack ties or beats all other hands, the advantage of immediately checking the hole card is that the game can be quickly ended and wagers collected if the dealer has blackjack without having to play out every hand, thereby wasting time.

The dealer then offers each player, in succession from the dealer's left to right, the opportunity to accept additional playing cards. Each player's hand is completed before the dealer offers the next player the opportunity to receive additional playing cards. Accepting playing cards is commonly referred to as “hitting” or taking a “hit.” At each player's turn, the player may accept playing cards, one at a time, trying to build a hand with a point value as close to twenty-one as possible, without going over twenty-one. The player may decline further playing cards at anytime, which is commonly referred to as “standing.” The player's hand is immediately terminated if its point value exceeds twenty-one, which is commonly referred to as a “bust” or “busted.” If the player busts, or has a natural twenty-one (i.e., blackjack), the dealer completes the player's hand and places that player's playing cards into a discard holder. Before receiving a third playing card after the initial hands are dealt, a player can split the player's initial hand. This is commonly referred to as splitting. The player uses one of the initial playing cards to form a new hand, placing a wager for the new hand, and retains the other of the initial playing cards as a part of the original hand.

After each player in turn has declined to accept further playing cards, the dealer may accept further playing cards from the deck. Casinos have rules based on the point value of the dealer's hand that dictate when the dealer must take an additional playing card from the deck (i.e., hit) and when the dealer must decline further additional playing cards (i.e., stand). For example, many casinos require the dealer to stand if the dealer's hand has a point value of seventeen or more. Some casinos permit the dealer to take an additional playing card if the point value of the dealer's hand is a soft seventeen, that is, if the point value of the dealer's hand is seventeen by counting an Ace held by the dealer as eleven.

If the dealer busts, player who have not also busted win. If the dealer does not bust, all remaining players and the dealer must display their hands to allow the dealer to compare the value of each of the player's hands to the value of the dealer's hand. Those players having a hand with a higher point value than the dealer's hand, and who have not exceeded twenty-one win. The winning players are paid based on the size of their wager and the odds. The wagers of losing players are collected, and the dealer collects the playing cards remaining on the gaming table in a particular order. Blackjack includes additional rules such as “doubling down” and “insurance” bets, and other variations that are commonly known by those who play Blackjack, and will not be further described in the interest of brevity.

Blackjack may be played with one deck or multiple decks of playing cards. When multiple decks are used, the playing cards are loaded into a “shoe.” Utilizing multiple decks of playing cards helps to mitigate any unfair advantage that might be gained by a participant or participants who may attempt to count cards. Numerous card-counting systems are known, and typically rely on a participant keeping a mental count of some or all of the playing cards, which have been played. For example, in the game of twenty-one it is beneficial to determine when all playing cards with a rank of 5 have been dealt (i.e., Fives strategy). Since playing cards with a value of ten favor the player over the house, it is also beneficial to determine the number of playing cards remaining in the deck(s) having a point value of ten (i.e., Tens strategy). Other variations of card counting are well known in the art.

Shuffling of the playing cards is typically done either manually by the dealer or with a mechanical shuffler. The playing cards are typically reshuffled and/or new decks employed several cards before the end of the shoe, in a further effort to hinder card counting, which is particularly effective when only a few hands of playing cards remain (i.e., end game strategy). The ratio of the number of playing cards dealt to the total number of playing cards remaining in the shoe or deck(s) is commonly known as the deck penetration.

Another popular card game is known as Baccarat, which is derived from European Baccarat and chemin de fer. There are three standard variations of Baccarat, standard or Big-Baccarat, Midi-Baccarat, and Mini-Baccarat. The significant difference between the three versions is that in Big-Baccarat, each of the seated participants takes a turn dealing the playing cards, in Midi-Baccarat, each of the gaming participants takes a turn dealing only the Player's hand, and in Mini-Baccarat, none of the seated participants touch the playing cards—a designated casino dealer handles the playing cards.

In Baccarat, only two hands are dealt, one hand represents the Banker's hand and the other represents the Player's hand. The participants in the game are the actual individuals seated at the Baccarat table. The casino typically plays the role of the banker. The object of the game is for the participants to bet on which one of the two hands, the Player's hand or the Banker's hand, will come closest to a total of nine points or whether the hands will tie. The value of the hand is determined by the rank of the playing cards. Thus, cards having rank Ace-10 have the value 1-10 respectively. Face cards (i.e., Jack, Queen, King) each have the value 10. A hand that is worth 8 or 9 points is generally referred to as a natural. A hand totaling nine is more specifically referred to as le grand natural, while a hand totaling eight is referred to as le petit natural. If the total of a hand exceeds the value of “ten,” the hand is scored by dropping the tens-place integer. For instance, if a hand consists of a five and a King, which totals fifteen, the value of the hand is five after dropping the tens-place integer. In a hand with a Ten and a Queen, which totals twenty, the value of the hand is zero. Suits have no bearing on the game of Baccarat. Each hand consists of at least two playing cards, but no more than three. The Player's initial hand consists of the first and third playing cards dealt. The Banker's initial hand consists of the second and fourth playing cards dealt. A third playing card for the respective hand may or may not be drawn according to fixed rules shown below.

Rules For The Player's Hand:

| | Based On The Total of the |
|---|---|
| Total of Player's | Player's Initial Cards, The |
| Initial Cards: | Player Must: |
| 0, 1, 2, 3, 4, or 5 | DRAW a third card |
| 6 or 7 | STAND |
| 8 or 9 | STAND (Natural) |

Rules For The Banker's Hand:

| | | Based On The Total of the |
|---|---|---|
| | The Player's | Banker's Initial Cards and the |
| Total of Banker's | Third | Value of the Player's Third Card, |
| Initial Cards: | Card Is: | The Banker Must: |
| 0, 1, or 2 | 0-9 | DRAW |
| 3 | 0-7 or 9 | DRAW |
| | 8 | STAND |
| 4 | 2-7 | DRAW |
| | 0-1, 8 or 9 | STAND |
| 5 | 4-7 | DRAW |
| | 0-3, 8 or 9 | STAND |
| 6 | 6-7 | DRAW |
| | 0-3, 8 or 9 | STAND |
| 7 | 0-9 | STAND |
| 8-9 | 0-9 | STAND (Natural) |

In addition to the above rules, Baccarat includes a unique gaming table for the placement of wagers and for the display of both the Player's and Banker's hands, however, the overall Baccarat environment will not be further described in the interest of brevity.

Card games are particularly popular in casinos and other gaming establishments. Participants wager large sums of money while playing card games, thus, it is desirable to ensure that those playing the game are not cheating, for example by utilizing card-counting strategies, substituting one or more cards into the deck or hand, or marking cards. Further, it is desirable to monitor the game in a relatively unobtrusive manner to allow casino customers to feel comfortable in their surroundings.

### BRIEF SUMMARY OF THE INVENTION

In one aspect, an apparatus for automatically determining whether a dealer has an automatically winning hand in a card game played by a number of participants including at least one player and the dealer includes a playing card reading means for reading identifiers from a number of playing cards before the playing cards are received by respective ones of the participants in the card game; a processor coupled to the playing card reading means to receive signals indicative of the read identifiers and to receive signals indicative of a number of hands in the card game, the processor further configured to determine a value of a dealer's initial hand composed of a first two playing cards dealt to the dealer based on the received signals and to determine whether the determined value of the dealer's initial hand is equal to a defined value; and an indicator coupled to the processor for control thereby to provide a human perceptible indication indicative of the value of the dealer's initial hand being equal to the defined value.

In another aspect, a method for automatically determining whether a dealer has an automatically winning hand in a card game played by a number of participants including at least one player and the dealer includes reading identifiers from a number of playing cards before the playing cards are received by respective ones of the participants in the card game; determining a value of a dealer's initial hand composed of a first two playing cards dealt to the dealer based at least in part on the identifiers read from the number of playing cards before the playing cards are received by respective ones of the participants in the card game and at least in part on a number of hands participating in the card game; determining whether the determined value of the dealer's initial hand is equal to a defined value; and providing a human perceptible indication indicative of the value of the dealer's initial hand being equal to the defined value.

In yet another aspect, a method for determining a value of an initial hand of playing cards includes determining a number of participants in the card game to include at least one player and one dealer; and determining a number of playing cards necessary to provide each participant with an initial hand of playing cards according to a set of rules for the card game; determining an initial sequence of the number of playing cards by reading identifiers from the number of playing cards; and determining the value of at least one initial hand of playing cards dealt from the initial sequence.

In yet another aspect, a system for determining a value of an initial hand of playing cards includes means for determining the number of initial hands for a current card game; a housing to hold at least the number of initial hands for the current card game, the cards selectively removable from the housing; means for reading an indicia from at least each of the number of cards forming the initial hands, the means for reading positioned to read at least the number of initial hands within the housing; means for processing an amount of data acquired from reading the indicia; and means for determining the value of at least one initial hand before all of the initial hands have been dealt.

### BRIEF DESCRIPTION OF THE SEVERAL VIEWS OF THE DRAWING(S)

In the drawings, identical reference numbers identify similar elements or acts. The size and relative positions of elements in the drawings are not necessarily drawn to scale. For example, the shapes of various elements are not drawn to scale, and some of these elements are arbitrarily enlarged and positioned to improve drawing legibility. Further, the particular shapes and the elements are not intended to convey any information regarding the actual shape of the particular elements, and have been solely selected for their ease and recognition in the drawings.

FIG. 1 is a top plan view of a card shoe according to one embodiment.

FIG. 2 is a front elevational view of the card shoe of FIG. 1.

FIG. 3 is a cross-sectional view of the card-shoe of FIG. 1, showing a card reader positioned to read identifiers from playing cards in the card shoe.

FIG. 4 is a top plan view of a card shoe according to another embodiment showing a card reader positioned to read identifiers from playing cards as the playing cards are removed from the card shoe one-at-a-time.

FIG. 5 is a front elevational view of a stacked set of playing cards, each of the playing cards carrying machine-readable indicia on a face of the playing cards.

FIG. 6 is a top plan view of an initial hand of playing cards.

FIG. 7 is a flow chart showing a method of operating the card and associated processor to determine a value of at least one initial hand of playing cards according to one embodiment.

FIG. 8 is a flow chart showing a method of operating a game of Blackjack employing the card shoe, processor and method of FIG. 7.

FIG. 9 is a flow chart showing a method of operating a game of Baccarat employing the card shoe, processor and method of FIG. 7.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with cameras, imagers, scanners, optics, computers, computer networks, data structures, databases, and networks such as the Internet, have not been describe in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

Reference throughout this specification to “one embodiment” or “an embodiment” means that a particular feature; structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

Reference throughout this specification of the terms “dealer,” “player” and “participant” are merely used for reference purposes to identify the respective parties. The term “participant” as used within the specification and claims may include the player as well as the dealer, if in fact the particular card game has a dealer. For example, in the game of Blackjack, the dealer may be considered to be a participant because the dealer actively receives and makes decisions based on the present value of the dealer's hand.

The methods for determining a value of an initial hand of playing cards may be accomplished with various devices. For example, a card shoe may include a card reader, as described in detail below, to read identifiers from playing cards before, or as, the playing cards are removed from the card shoe. Alternatively, other devices may generate a pseudo-random playing card sequence, and sort, shuffle, print or otherwise produce the playing cards such that the playing cards are distributed from the card shoe in order of the pseudo-random playing card sequence. In either case, the initial sequence of playing cards is known before all of the playing cards reach a particular participant's hand. It is thus possible to determine a value of the particular participant's hand at a point before the last playing card reaches the particular participant's hand. Such a determination may be advantageous in a number of circumstances, without effecting the outcome of the game or wagers placed on the game. For example, such a device can determine whether a dealer's initial hand in a game of Blackjack constitutes a blackjack (i.e., initial two cards total twenty-one), allowing the game to be terminated before each player takes hit cards and thereby increasing the number of games which may be dealt. Such a device may replace the “no peak” devices currently employed on many Blackjack tables.

Devices for Reading an Initial Sequence of Playing Cards

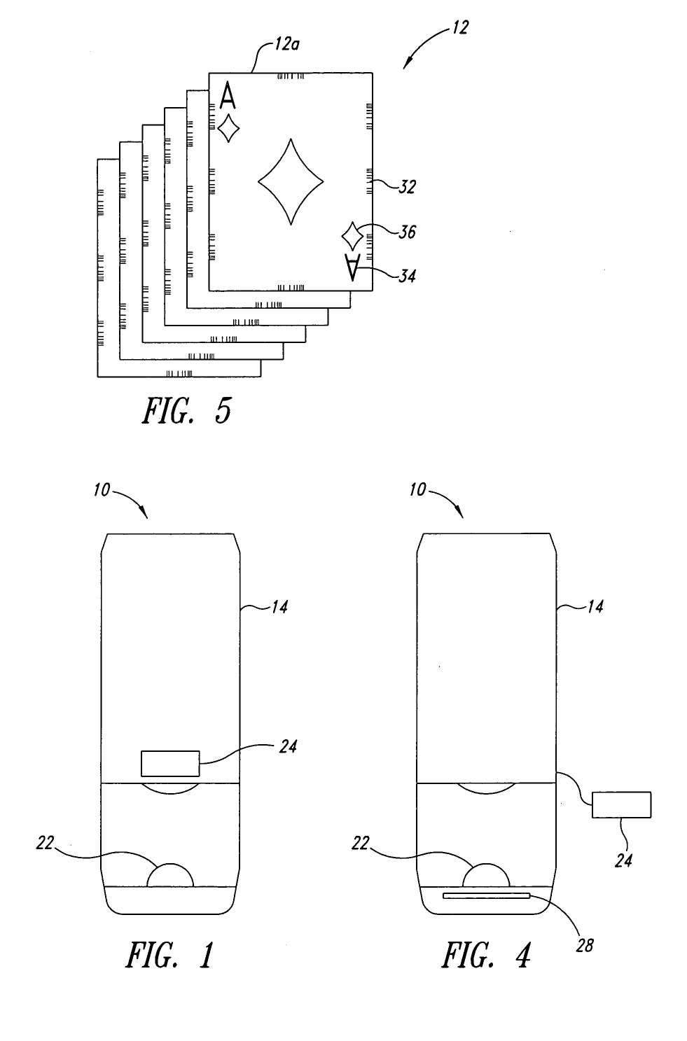

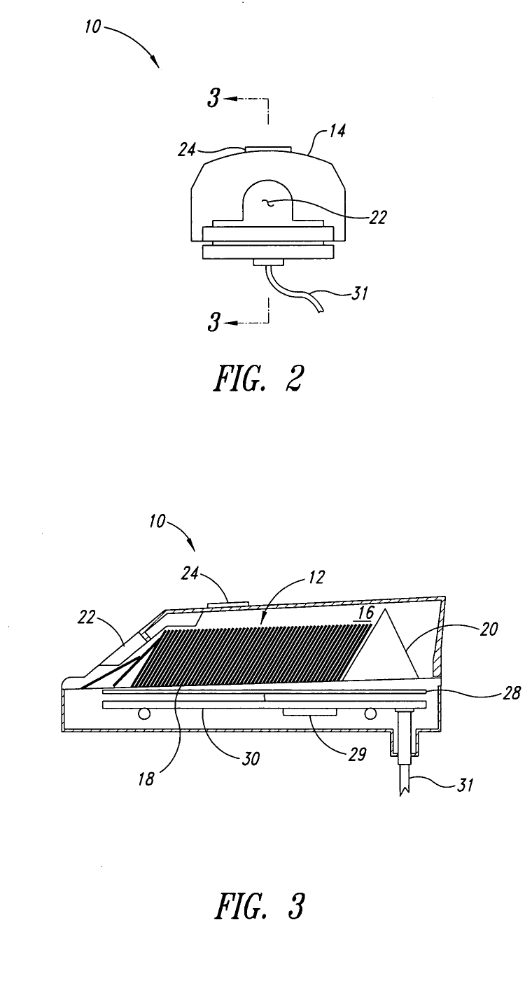

FIGS. 1-3 illustrate a card shoe 10 for distributing a set of playing cards 12 for use in playing a card game according to one embodiment. The card shoe 10 includes a housing 14 having a receptacle 16 sized and dimensioned to receive the set of playing cards 12. Card shoes typically hold from two to eight standard decks of playing cards (e.g., 52 playing cards per deck), although those of skilled in the art will appreciate that the receptacle may be sized to accept a greater or lesser number of playing cards 12. The playing cards 12 are carried on a sloped surface 18, and the card shoe 10 typically includes a weight or wedge 20 that urges the playing cards 12 toward an opening 22 at the front of the card shoe 10 under the force of gravity. The card shoe 10 may employ other mechanisms including mechanical transports or drives to advance the playing cards 12 toward the opening 22. The opening 22 permits a dealer, or in the case of Baccarat a player, to easily remove the playing cards 12 from the card shoe 10. Typically, the dealer or player removes the playing cards 12 one-at-a-time from the card shoe 10. Alternatively, the dealer or player may remove the playing cards 12 in sets or groups, for example, for use in card games dealt from a handheld deck. In use, the card shoe 10 may sit on the surface of a gaming table (not shown), may be located in or under the surface of the gaming table, or may be in some other location proximate the gaming table.

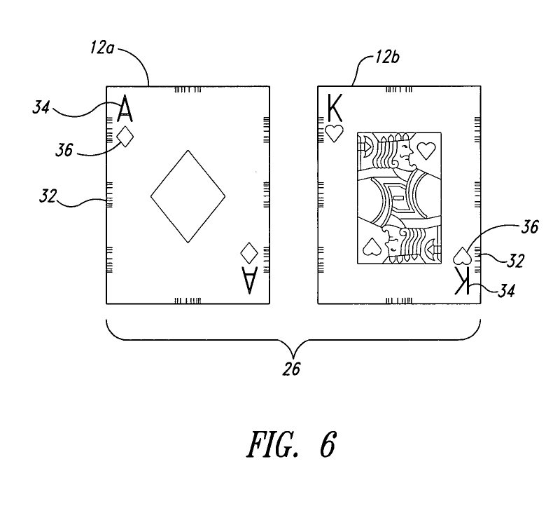

The card shoe 10 may include a user interface 24 to receive information from and/or provide information to the dealer and/or players. The user interface 24 may take any of a variety of forms such as one or more light emitting diodes (LEDs), liquid crystal displays (LCDs), incandescent lights, speakers, bells, or other device for producing human perceivable information. The user interface 24 may include user-activated switches such as buttons, keys, trackball, joystick, and/or touch sensitive screen. The user interface 24 may be carried by the card shoe 10 as illustrated in FIGS. 1-3, or alternatively, may be separate from the card shoe 10 as illustrated in FIG. 4. The user interface 24 may be position so as to be visible only to the dealer, or may be positioned so as to be visible to all participants. The user interface 24 may, for example, provide notification that a particular initial hand has a certain value. For example, the user interface 24 may provide notification that an initial hand 26 (FIG. 6) has a certain value. For example, in the game of Blackjack, the user interface 24 may indicate whether the dealer's initial hand 26 has a value of twenty-one. Alternatively, during the game of Baccarat, the user interface 24 may provide notification to all of the gaming participants that the value of one or both of the Player's or Banker's initial hands constitutes a “natural” (i.e., a value of nine).

The card shoe 10 may include a card reader 28 for reading identifying information (e.g., rank, suit, serial number, unique alpha-numeric identifier, etc.) from the playing cards 12. The card reader 28 may take a variety of forms, depending on the method or structure of encoding the identifying information on the playing cards 12. For example, the card reader 28 may take the form of one or more optical sensors for reading optically encoded identifying information, for example, identifying information encoded as machine-readable symbols such as barcode symbols carried by the playing cards 12. Also, for example, the card reader 28 may take the form of one or more magnetic sensors (not shown) where the playing cards 12 include magnetic particles (e.g., remanent or magnetic strip) encoding the identifying information. As a further example, the card reader 28 may take the form of a wireless receiver and/or transceiver (not shown), for example, where the playing cards 12 carry an active or passive resonator or transponder such as a radio frequency identification (RFID) circuit.

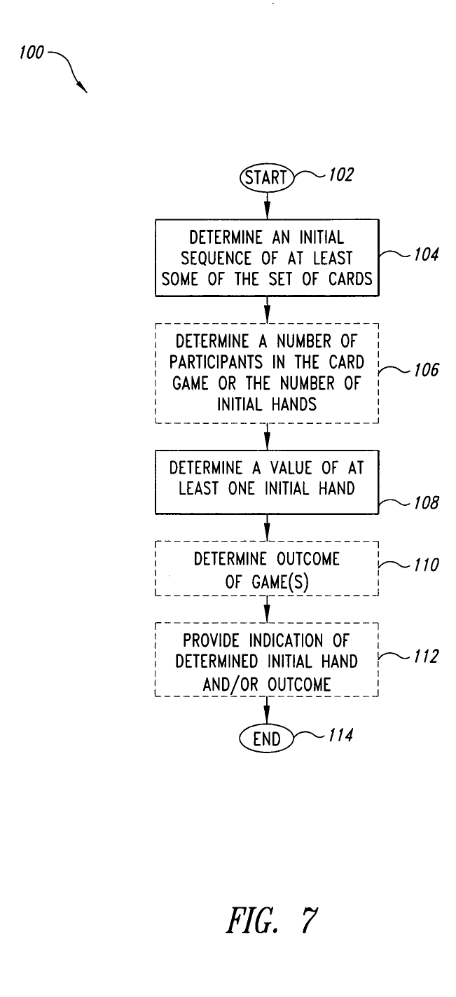

As illustrated in FIG. 3, the card reader 28 may be positioned to read the identifying information from the playing cards 12 while the playing cards 12 are in the receptacle 16. For example, the playing cards 12 may be stacked in the receptacle 16 in a fashion similar to that illustrated in FIG. 5, where the amount of stagger in both directions is exaggerated, so that at least one identifying information bearing edge of each playing card 12 is exposed. The card reader 28 may include optical and/or electro-optical components to scan, image, and/or otherwise optically sense identifiers from some or all of the playing cards 12 in the receptacle 16, for example, before a first one of the playing cards is removed from the card shoe 10. The optical components may include one or more lens, mirrors, prisms, reflectors, refractors and/or other optical components. The electro-optical components may include one or more scanners such as a laser scanner, or imagers such as one or two-dimensional arrays of photosensitive devices such as Charge Coupled Devices (CCDS), photo-multiplier tubes, vidicons, CMOS imagers, and may capture still images via a still camera or moving images such as video images, for example via a video camera.

Alternatively, as illustrated in FIG. 4 the card reader 28 may be positioned to read the identifying information from the playing cards 12 as the playing cards 12 are withdrawn from the card shoe 10. For example, the card reader 28 may be positioned to read identifiers from each playing card 12 one-at-a-time, as the playing card is withdrawn from the card shoe 10 in a manner similar to that taught in U.S. Pat. No. 5,374,061 and U.S. Pat. No. 5,722,893.

The card shoe 10 may include one or more processors 29, for example, microprocessors, digital signal processors (DSPs), or application specific integrated circuit (ASICs), and associated random access memory (RAM) and/or read only memory (ROM) carried, for example, on a printed circuit board 30. The processors may execute appropriate software or firmware instructions for controlling various components, such as the card reader 28, and for decoding and/or decrypting identifiers read from the playing cards 12 or for otherwise processing the initial sequence of playing cards 12. While FIG. 3 illustrates the processor 29 being housed with the card shoe 10, in some embodiments the processor 29 may be located away from the card shoe 10, for example, under the gaming table, or even in a secure area away from the floor of the casino. In such an embodiment, the processor may take the form of a programmed general purpose computing system such as a personal computer, workstation, mini-computer or mainframe computer.

The card shoe 10 may further include one or more communication devices such as a communications port 31 for transmitting and/or receiving data, for example, identification information and/or the initial sequence of playing cards 12. The communications port 31 may, for example, allow the processor 29 to be located separately from the card shoe 10. As is typical in the automatic data collection (ADC) arts, processing may include amplifying the signal from the detector, analog-to-digital conversion or “wave-shaping” of the amplified signal, and decoding the converted signal into characters represented by the symbols forming the machine-readable indicia. Where the identifying data is encoded into a machine-readable symbol, the processing typically includes converting an analog signal representing variations in reflectance into digital data, and interpreting the digital data as meaningful information based on the underlying symbology (i.e., a mapping of machine-readable indicia, typically defined in terms of patterns of reflectance, to human-understandable characters).

The card shoe 10 may also be detachable from one or more components of the card reader 28. In addition, the card shoe reader 10 may be coupled to, or merely placed on a gaming table (not shown), or placed proximate the gaming table. The various configurations of the card shoe 10, the configuration and function of the reader 28, etc., and the advantages of having the card shoe connected or not connected to the gaming table are discussed in detail in U.S. Provisional Patent Application No. 60/500,898, filed Sep. 5, 2003, entitled “SYSTEMS, METHODS, AND DEVICES FOR MONITORING CARD GAMES, SUCH AS BACCARAT.”

Playing Cards

FIGS. 5 and 6 illustrate a stack of playing cards 12 and the initial hand 26 of two playing cards 12a, 12b, respectively. As discussed above, the identifier may take the form of a machine-readable symbol 32 carried along one or more edges of the playing cards 12. Additionally, or alternatively, the standard rank markings 34 and/or suit markings 36 may comprise the identifiers. Methods and structures for reading and processing the identifiers are discussed more fully in U.S. patent application Ser. No. 10/017,276, filed Dec. 13, 2001, entitled “METHOD, APPARATUS AND ARTICLE FOR RANDOM SEQUENCE GENERATION AND PLAYING CARD DISTRIBUTION;” U.S. patent application Ser. No. 10/360,846, filed Feb. 5, 2003, entitled “METHOD, APPARATUS AND ARTICLE EMPLOYING MULTIPLE MACHINE-READABLE INDICIA ON PLAYING CARDS;” and U.S. patent application Ser. No. 60/500,898, filed Sep. 5, 2003, entitled “SYSTEMS, METHODS, AND DEVICES FOR MONITORING CARD GAMES, SUCH AS BACCARAT.”

Alternatively, in some embodiments the card shoe 10 may be loaded with a set of playing cards 12 with a predetermined or known sequence. It may be preferable to incorporate a card reader 28 in the card shoe since it is common practice among casinos to remove several playing cards (i.e., “burn cards”) from a new or replacement card shoe 10, prior to dealing a first card 12 therefrom. The number of burn cards selected is typically a matter of individual casino policy and the burn process is usually performed on a fresh set of playing cards 12. The card reader 28 can provide that the sequence is determined after the burn cards are removed. Otherwise, the burn cards may be accounted for where the number of bum cards is fixed, or otherwise provided such as entered by the dealer via a user interface.

In an alternative embodiment, the card shoe 10 may take the form of a card distribution device such as a card shuffling device that can generate a pseudo-random playing card sequence and distribute the playing cards in the order of the pseudo-random playing card sequence. Such a device is described in detail in U.S. Provisional Patent Application No. 60/509,802, filed Oct. 8, 2003, entitled “METHOD, APPARATUS AND ARTICLE FOR RANDOM SEQUENCE GENERATION AND PLAYING CARD DISTRIBUTION,” and U.S. Provisional Patent Application No. 60/543,856, filed Feb. 10, 2004, entitled “METHOD, APPARATUS AND ARTICLE FOR COMPUTATIONAL SEQUENCE GENERATION AND PLAYING CARD DISTRIBUTION.” In brief, the card shuffling device utilizes a processor to computationally generate a pseudo-random playing card sequence and employs an electro-mechanical system to sort or shuffle playing cards and to distribute the playing cards according to the computationally generated pseudo-random sequence. Thus, at least a portion of the sequence is determined before the corresponding playing cards 12 are dealt. Where the number of participants is known, the identities of the playing cards that will form the initial hand(s) 26 may be determined at any time before the participant receives the final card in the initial hand (e.g., the second playing card in Blackjack).

In a further alternative, the card shoe 10 may take the form of a card printing and distribution device that can generate a pseudo-random playing card sequence, print, and distribute playing cards 12 in the order of the pseudo-random sequence. Such a device is described in detail in U.S. patent application Ser. No. 10/017,276, filed Dec. 13, 2001, entitled “METHOD, APPARATUS AND ARTICLE FOR RANDOM SEQUENCE GENERATION AND PLAYING CARD DISTRIBUTION.”

Methods of Determining a Value of an Initial Hand of Playing Cards

As discussed above, there are various approaches to determining at least a portion of the initial sequence in which the playing cards 12 will be distributed or dealt, including optically reading identifiers, magnetically reading identifiers; wireless interrogating transponders or other RF circuitry such as RFID chips, and computationally generating a pseudo-random sequence. The initial sequence 28 comprises at least a sufficient number of playing cards 12 such that each participant, including the dealer if the dealer receives playing cards in the particular game, may receive an initial hand 26 of playing cards, wherein the initial hand 26 consists of at least two playing cards. The initial sequence in the game of Blackjack, for example, would consist of at least four cards (i.e., initial hand of two playing cards for the dealer and for at least one player). Alternatively, in Baccarat, the initial sequence 28 would consist of only four cards (i.e., initial hand of two playing cards dealt to the Player and the Banker).

By determining an initial sequence of the playing cards 12, a value for at least one of the initial hands 26 or all of the initial hands 26 may be determined. In some card games, however, one skilled in the art will understand that there may only be a need to determine a value for a particular initial hand 26. For example, determining the value of the dealer's initial hand 26 in the game of Blackjack may determine whether the remainder of the game must be played (e.g., must players take hit cards). The value of the initial hand 26 is dependent on the type of card game being played and the rules of the game.

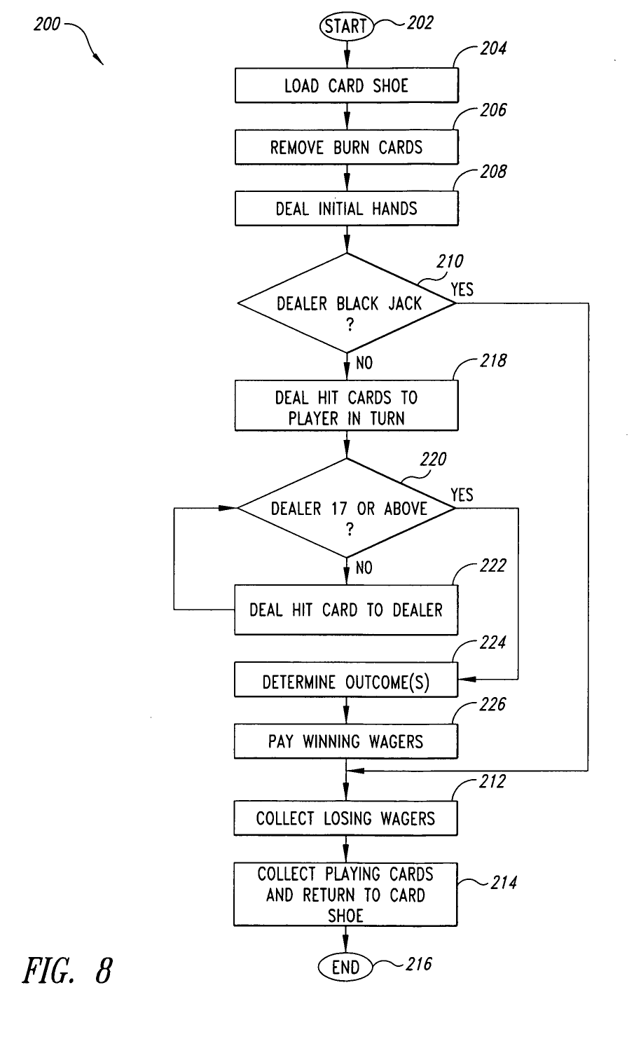

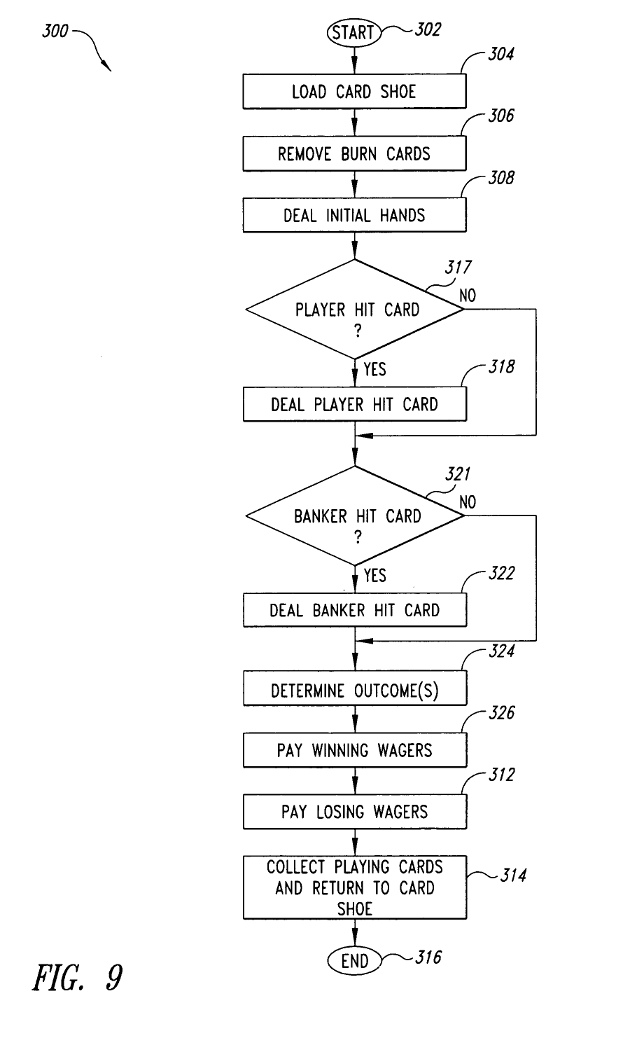

FIG. 7 illustrates a method 100 of operating a card shoe 10 and associated processor 29 to determine a value 30 of at least one initial hand 26 of playing cards 12, starting at 102. FIG. 8 illustrates a method 200 of operating a Blackjack game starting in step 202, employing the card shoe 10. FIG. 9 illustrates a method 300 of operating a Baccarat game starting in step 302, employing the card shoe 10. The following discussion will make references to FIGS. 7-9 in order to illustrate various methods of operating the card shoe 10, but also to illustrate various possible interactions between the operation of the card shoe 10 and the operation of the particular exemplary games of Blackjack and Baccarat. The methods 200 and 300 share many similar steps, which is indicated by the use of reference numbers that share the final two digits in common, as will be apparent from the following description.

At 204, 304, the dealer or some other casino personnel load the card shoe 10. Typically, the casino personnel initially load the card shoe 10 with multiple decks of playing cards 12. The loading may take place in a secure area. The card shoe 10 is then placed on the gaming table, for use during one or more shifts. Where the card shoe 10 includes a printer for printing or otherwise forming standard markings on the playing cards 12 in real or almost real time, loading the card shoe 10 may take the form of loading blank card stock, or loading partially printed card stock into the card shoe 10.

At 206, 306, the dealer may remove a number of burn cards from the card shoe 10. Typically, casinos have a standard policy to “burn” several playing cards from each card shoe 10 or deck of playing cards 12 before game play commences.

At 104, the card reader and/or processor 29 determines an initial sequence of at least some of the playing cards 12. For example, the card reader 28 may scan or image identifiers from a number or all of the playing cards 12 in the receptacle 16 before one or more of the playing cards 12 are removed from the card shoe 10. The processor 29 may receive playing card identifying information from a card reader 28 and decode and/or otherwise process the card identifying information to determine an identity and/or value of each of the playing cards 12. For example, the card reader 28 may scan or image a barcode, stacked code or area code symbol printed on an edge of each playing card 12 in an ink that is not visible to humans. The processor 29 can decode the read symbols into alphanumeric serial numbers that uniquely identify each playing card 12, and from which the rank and/or value may be determined. Alternatively, each playing card 12 may be scanned or imaged as the playing card 12 is withdrawn from the card shoe 10, such as illustrated in FIG. 4.

Other approaches to determining an initial sequence 104 may include magnetically reading magnetic stripe or remanent particles, for example via a magnetic sensor or read head, or wirelessly reading identifying information from the playing cards 12, for example via a radio frequency identification (RFID) interrogator or other wireless transceiver or receiver.

Alternatively, or additionally, the processor 29 may determine the initial sequence 104 by generating or receiving the initial sequence in the form of a computationally generated pseudo-random sequence, for example, where the card shoe 10 employs a sorting or shuffling mechanism or where the card shoe 10 employs a printing or image forming mechanism. In a further alternative, the determining the initial sequence 104 may occur before the playing cards 12 are loaded 204, 304 where the initial sequence is provided to the processor 29, for example via the communications port 31.

Optionally, the processor 29 determines a number of participants or initial hands in the card game at 106. This determination may be unnecessary in certain card games where the number of participants or initial hands is fixed or known beforehand, for example Baccarat where there are always only two hands played in the game. In Blackjack, however, the number of initial hands 26 varies from game-to-game. Typical Blackjack tables accommodate from two to eight participants, including the dealer, each receiving a respective initial hand. Thus, in order to determine the value of the dealer's initial hand 26, the number of players must be known. The number of players may vary from one game to the next, as some players leave the gaming table and new players join.

One method of determining the number of participants 106 is for the dealer to count the participants before the start of each card game, with the total number of participants including the dealer if the dealer will be dealt a hand. The dealer may provide the count to the processor 29 via a user interface 24 or relay the count so that someone else can provide the count to the processor 29.

Alternatively and additionally, the system may employ an automated approach to determining the number of participants 106, for example relying on electrical, electro-mechanical and/or optical sensing devices.

In one embodiment, sensing devices may be located at each of the participant seating stations at the gaming table. For example, a player identification reader may be located at each seating station, which reads player identifying information from player identification cards, commonly referred to as “comp” cards. Also for example, a light source and detector pair may be associated with each seating station, for example, located in the gaming table at a betting or wager circle where the player locates chips in order to places wagers or bets. The detector may detect the presence and/or absence of light, thus determining whether a wager has been placed, and consequently whether a card hand will be dealt. As a further example, an RFID interrogator may have an antenna at each seating position or wager circle, and may interrogate gaming chips placed as wagers in the wager circles.

In another embodiment, sensing devices may be located centrally to detect player presence or absence at each of the participant seating stations at the gaming table. For example, at least one optical sensing device may be configured to optically detect the presence/absence of a participant at a given seating station of the gaming table. For example, one or more still or video cameras located in a chip tray or in turrets on the gaming table may image the wagering or betting circles typically found on the surface of gaming tables, and may detect the placement of wagers in the form of chips. Each wager circle having chips will receive an initial hand of playing cards. Other methods of determining the number of participants 106 will become apparent to those of skill in the art from the teachings herein.

At 108, the processor 29 determines the value of at least one of the initial hands 26. The processor 29 may determine the identities of the playing cards 12a, 12b forming the initial hand 26 based on the initial sequence of playing cards in the card shoe 10, the rules of the game and/or the number of participants. The processor 29 may determine the value of the initial hand 26 from the identities of the playing cards 12a, 12b forming the initial hand 26.

For example, for a game of Blackjack, given a number of participants n, the processor 29 can determine that the dealer will receive the nth and the 2*nth playing card in the initial sequence as the dealer's initial hand 26. This is based on the initial sequence, the number of participants, and the rules of Blackjack which defines the dealing pattern as dealing one card to each participant starting with the player on the dealer's left, then sequentially to each seated participant in the direction of the dealer's right, and finally to the dealer, and then repeating the process for a second playing card to each participant.

The processor 29 can likewise determine the identity and values of the initial hands for each of the players. Given the values of the initial hands of the dealer and the player(s), the processor 29 in some instances may be able to determine an outcome of the game, as illustrated by optional act 110. For example, if the dealer has blackjack, the best outcome a player may expect is a tie or push if the player also has blackjack. The processor 29 can determine can whether the player has blackjack, thus determining the outcome of the game.

The act of determining at least one of the initial hands 108 and/or determining of the outcome of the game 110 may occur before, or after, the dealer deals the initial hands 208. For example, the determinations 108, 110 may occur before a first card is removed from the card shoe 10, before a first card is received by all or any one of the participants; or before a last card that forms the initial hand is received by all or any one of the participants.

At 112, the processor 29 may indicate the outcome of the determination. For example, the processor 29 may cause the user interface 24 to display a message or otherwise indicate that the dealer has blackjack. The dealer may determine that they have blackjack as at 210, and in response may terminate the game either immediately, or after some time, thus avoiding the need to deal further playing cards (e.g., hit cards) to the players, and thereby increasing the number of hands that may be dealt during the dealer's shift. In terminating the game the dealer may collect losing wagers 212 and collect the playing cards 214, which may be returned to the card shoe 10 for eventual reuse in some embodiments, at which point the method 200 terminates at 216.

If the dealer does not have blackjack, the dealer deals hit cards to each of the players in turn, at 218. The dealer then determines whether the dealer has seventeen or above at 220. (Note, some casinos differentiate between a hard and a soft seventeen, which may be easily accommodated in the described method). If the dealer has less than seventeen, the dealer deals themselves a hit card at 222, until the value of the dealer's hand is equal to or greater than seventeen.

At 224, the dealer determines the outcome of the games, comparing the value of each player's hand to the value of the dealer's hand. At 226, the dealer pays off winning wagers, collects losing wagers at 212, and collects and returns the playing cards to the card shoe at 214. The method 260 terminates or repeats at 216.

For example, for a game of Baccarat, the number of participants receiving playing cards is always two, thus the processor 29 can determine that the player will receive the first and third playing cards in the initial sequence as the player's initial hand 26, while the banker will receive the second and fourth playing cards in the initial sequence as the banker's initial hand 26, as per 108. Thus, the processor 29 determines the value of each initial hand 108 based on the initial sequence, and the rules of Baccarat which define the number of participants and the dealing pattern as dealing one card to each participant starting with the player and ending with the banker, and then repeating the process for a second playing card to each participant.

Further, since the rules for taking playing cards in Baccarat are fixed, and there is no decision-making by either the player or the banker, the processor 29 may determine the identity and value of each and every hand that will be dealt from the card shoe 10 based on the initial sequence at any time before of after a playing card is removed from the card shoe 10 and/or received by the player or banker. Consequently, the processor 29 can determine an outcome of each game 110 that will be dealt from the card shoe 10 based on the initial sequence of playing cards 12 in the card shoe 10, as per 110.

The act of determining at least one of the initial hands 108 and/or determining of the outcome of the game 110 may occur before, or after, the dealer deals the initial hands 308. For example, the determinations 108, 110 may occur before a first card is removed from the card shoe 10, before a first card is received by all or any one of the participants; or before a last card that forms the initial hand is received by all or any one of the participants.

At 317 the caller or banker determine whether the player requires a hit card, based on the total value of the player's hand. At 318 the banker deals a hit card to the player, if the player requires a hit card according to the rules of Baccarat. At 321, the caller or banker determine whether the banker requires a hit card, based on the total value of the banker's hand. At 322, the banker is dealt a hit card if a hit card is required according to the rules of Baccarat.

At 324, the caller determines the outcome of the games, comparing the value of each player's hand to the value of the dealer's hand. At 326, the caller pays off winning wagers, collects losing wagers at 312, and collects and returns the playing cards to the card shoe at 214. The method 300 terminates or repeats at 316.

At 112, the processor 29 may indicate the outcome of the determination. For example, the processor 29 may cause the user interface 24 to display a message or otherwise indicate whether the player or banker has won or whether there is a tie or push, allowing the results to be verified. This may be particularly advantageous since the players and spectators may monitor the game and ensure that the announced results match those indicated by the user interface 24.

Conclusion

Thus, it is possible for the processor 29 to determine the value of the initial hand 108 for any participant before the participant receives a final playing card forming that participant's initial hand. It is also possible for the processor 29 to determine the value of the initial hand for any participant before that participant receives any playing cards. Further, it is possible for the processor 29 to determine the value of the initial hand for any participant before any of the playing cards 12 are dealt from the card shoe 10 for the particular game or round of hands in Blackjack, and possible for the processor 29 to determine the value of the initial hand for any participant before any of the playing cards 12 are dealt from the card shoe 10 for all games or rounds of hands in Baccarat that will be dealt from the card shoe 10.

All of the above U.S. patents, U.S. patent application publications, U.S. patent applications, foreign patents, foreign patent applications and non-patent publications referred to in this specification and/or listed in the Application Data Sheet, including but not limited to U.S. patent application Ser. No. 10/017,276, filed Dec. 13, 2001, entitled “METHOD, APPARATUS AND ARTICLE FOR RANDOM SEQUENCE GENERATION AND PLAYING CARD DISTRIBUTION;” U.S. patent application Ser. No. 10/360,846, filed Feb. 5, 2003, entitled “METHOD, APPARATUS AND ARTICLE EMPLOYING MULTIPLE MACHINE-READABLE INDICIA ON PLAYING CARDS;” U.S. patent application Ser. No. 09/790,480, filed Feb. 21, 2001, entitled “METHOD, APPARATUS AND ARTICLE FOR EVALUATING CARD GAMES, SUCH AS BLACKJACK;” U.S. patent application Ser. No. 09/849,456, filed May 4, 2001, entitled “METHOD, APPARATUS AND ARTICLE FOR VERIFYING CARD GAMES, SUCH AS BLACKJACK;” U.S. patent application Ser. No. 10/017,277, filed Dec. 13, 2001, entitled “METHOD, APPARATUS AND ARTICLE FOR RANDOM SEQUENCE GENERATION AND PLAYING CARD DISTRIBUTION;” U.S. patent application Ser. No. 60/500,898, filed Sep. 5, 2003, entitled “SYSTEMS, METHODS, AND DEVICES FOR MONITORING CARD GAMES, SUCH AS BACCARAT;” U.S. Provisional Patent Application No. 60/509,802, filed Oct. 8, 2003, entitled “METHOD, APPARATUS AND ARTICLE FOR RANDOM SEQUENCE GENERATION AND PLAYING CARD DISTRIBUTION;” U.S. Provisional Patent Application No. 60/543,856, filed Feb. 10, 2004, entitled “METHOD, APPARATUS AND ARTICLE FOR COMPUTATIONAL SEQUENCE GENERATION AND PLAYING CARD DISTRIBUTION;” and U.S. Provisional Patent Application No. 60/511,931, entitled “METHOD, APPARATUS AND ARTICLE FOR DETERMINING AN INITIAL HAND IN A PLAYING CARD GAME, SUCH AS BLACKJACK OR BACCARAT” are incorporated herein by reference, in their entirety.

Although specific embodiments, and examples for, the invention are described herein for illustrative purposes, various equivalent modifications can be made without departing from the spirit and scope of the invention, as will be recognized by those skilled in the relevant art. The teachings provided herein of the invention can be applied to other systems for playing card games or developing card game systems, not necessarily the Blackjack or Baccarat gaming systems generally described above. For example, the teachings can employ networks, such as the Worldwide Web portion on the Internet, to interconnect the various described components or to perform at least some of the method steps. The various embodiments described above can be combined to provide further embodiments. For example, the illustrated methods can be combined, or performed successively. The illustrated methods can omit some acts, can add other acts, and can execute the acts in a different order than that illustrated to achieve the advantages of the invention.

These and other changes can be made to the invention in light of the above detailed description. In general, in the following claims, the terms used should not be construed to limit the invention to specific embodiments disclosed in the specification, but should be construed to include all computers, networks and card-reading and evaluation systems that operate in accordance with the claims. Accordingly, the invention is not limited by the disclosure, but instead its scope is to be determined entirely by the following claims.

1. An apparatus for automatically determining whether a dealer has an automatically winning hand in a card game played by a number of participants including at least one player and the dealer, the apparatus comprising:
a playing card reading means for reading identifiers from a number of playing cards before the playing cards are received by respective ones of the participants in the card game;
a processor coupled to the playing card reading means to receive signals indicative of the read identifiers and to receive signals indicative of a number of hands in the card game, the processor further configured to determine a value of a dealer's initial hand composed of a first two playing cards dealt to the dealer based on the received signals and to determine whether the determined value of the dealer's initial hand is equal to a defined value; and
an indicator coupled to the processor for control thereby to provide a human perceptible indication indicative of the value of the dealer's initial hand being equal to the defined value.

2. The apparatus of claim 1 wherein the processor determines the value of the dealer's initial hand before a first card is dealt in the current card game.

3. The apparatus of claim 1 wherein the processor determines the value of the dealer's initial hand before the dealer receives a first card in the current card game.

4. The apparatus of claim 1 wherein the processor determines the value of the dealer's initial hand before the dealer receives a second card in the current card game.

5. The apparatus of claim 1 wherein the playing card reading means comprises at least one of an optical imager or a scanner.

6. The apparatus of claim 1, further comprising:
a card shoe forming a receptacle sized to hold at least two standard decks of playing cards.

7. The apparatus of claim 6 wherein the playing card reading means are positioned to read the playing cards as the playing cards are dispensed from the card shoe.

8. The apparatus of claim 6 wherein the playing card reading means are positioned to read the playing cards before the playing cards are dispensed from the card shoe.

9. The apparatus of claim 6 wherein the playing card reading means are housed in the card shoe.

10. The apparatus of claim 1, further comprising:
means for determining the number of hands in the card game.

11. The apparatus of claim 10 wherein the means for determining the number of hands in the card game comprises a number of sensors positioned to detecting a presence or an absence of players at each of a number of player positions at a gaming table.

12. The means of claim 10 wherein the means for determining the number of hands in the card game comprises a data entry keypad operable by a casino employee to enter the number of hands in the card game.

13. The means of claim 10 wherein the means for determining the number of hands in the card game comprises a number of player identity card readers configured to read player identification information from respective player identity cards.

14. The apparatus of claim 1 wherein the card game is blackjack, the defined value is twenty-one, and the automatically winning hand is a blackjack where the value of the dealer's initial hand is equal to twenty-one.

15. A method for automatically determining whether a dealer has an automatically winning hand in a card game played by a number of participants including at least one player and the dealer, the method comprising:
reading identifiers from a number of playing cards before the playing cards are received by respective ones of the participants in the card game;
determining a value of a dealer's initial hand composed of a first two playing cards dealt to the dealer based at least in part on the identifiers read from the number of playing cards before the playing cards are received by respective ones of the participants in the card game and at least in part on a number of hands participating in the card game;
determining whether the determined value of the dealer's initial hand is equal to a defined value; and
providing a human perceptible indication indicative of the value of the dealer's initial hand being equal to the defined value.

16. The method of claim 15 wherein determining whether the determined value of the dealer's initial hand is equal to a defined value occurs before a first card is dealt in the current card game.

17. The method of claim 15 wherein determining whether the determined value of the dealer's initial hand is equal to a defined value occurs before the dealer receives a first card in the current card game.:

18. The method of claim 15 wherein determining whether the determined value of the dealer's initial hand is equal to a defined value occurs before the dealer receives a second card in the current card game.

19. The method of claim 15 wherein reading identifiers from a number of playing cards before the playing cards are received by respective ones of the participants in the card game comprises at least one of imaging or scanning at least a portion of each of the playing cards.

20. The method of claim 15 wherein reading identifiers from a number of playing cards before the playing cards are received by respective ones of the participants in the card game comprises reading an identifier from each of the playing cards as the respective playing card is dispensed from a card shoe.

21. The method of claim 15 wherein reading identifiers from a number of playing cards before the playing cards are received by respective ones of the participants in the card game comprises reading an identifier from each of the playing cards before the respective playing card is dispensed from a card shoe.

22. The method of claim 15, further comprising:
determining the number of hands participating in the card game.

23. The method of claim 22 wherein determining the number of hands participating in the card game comprises detecting a presence or an absence of players at each of a number of player positions at a gaming table.

24. The method of claim 22 wherein determining the number of hands participating in the card game comprises receiving data entered at a keypad by a casino employee.

25. The method of claim 15 wherein the card game is blackjack, the defined value is twenty-one, and the automatically winning hand is a blackjack where the value of the dealer's initial hand is equal to twenty-one.

26. A method for determining a value of an initial hand of playing cards, the method comprising:
determining a number of participants in the card game to include at least one player and one dealer; and
determining a number of playing cards necessary to provide each participant with an initial hand of playing cards according to a set of rules for the card game;
determining an initial sequence of the number of playing cards by reading identifiers from the number of playing cards; and
determining the value of at least one initial hand of playing cards dealt from the initial sequence.

27. The method of claim 26 wherein determining the value of at least one initial hand of playing cards from the initial sequence occurs before a first playing card is presented to any one of the participants in the card game.

28. The method of claim 26 wherein determining the value of at least one initial hand of playing cards from the initial sequence occurs before a first playing card is presented to the dealer in the card game.

29. The method of claim 26 wherein determining the value of at least one initial hand of playing cards from the initial sequence occurs before a second playing card is presented to the dealer in the card game.

30. The method of claim 26 wherein determining an initial sequence of the number of playing cards by reading identifiers from the number of playing cards includes reading identifiers by one of imaging or scanning at least a portion of each of the playing cards.

31. The method of claim 26 wherein determining a number of participants in the card game includes detecting a presence or an absence of players at each of a number of player positions at a gaming table.

32. The method of claim 26 wherein determining a number of participants in the card game includes receiving data entered into a computing system by a casino employee.

33. The method of claim 26, further comprising:
determining if at least one of the initial hands dictates the outcome of the card game.

34. The method of claim 26 wherein determining if the initial hand received by the dealer during the game of Blackjack sums to a value of twenty-one.

35. A system for determining a value of an initial hand of playing cards, the system comprising:
means for determining the number of initial hands for a current card game;
a housing to hold at least the number of initial hands for the current card game, the cards selectively removable from the housing;
means for reading an indicia from at least each of the number of cards forming the initial hands, the means for reading positioned to read at least the number of initial hands within the housing;
means for processing an amount of data acquired from reading the indicia; and
means for determining the value of at least one initial hand before all of the initial hands have been dealt.

36. The system of claim 35 wherein the means for determining the number of initial hands is a computing system for receiving data from a casino employee, the data including the number of participants for the current card game.

37. The system of claim 35 wherein the means for determining the number of initial hands includes determining a number of participants for the card game.

38. The system of claim 35 wherein the means for determining the number of initial hands is an optical sensor positioned at a gaming table to detect a presence or absence of a participant at each of a number of seating locations around the gaming table.

39. The system of claim 35 wherein the housing to hold at least the number of initial hands supports the cards to enable the indicia on each card to be read.

40. The system of claim 35 wherein the means for reading an indicia from at least each of the number of cards forming the initial hands is an optical reading device.

41. The system of claim 35 wherein determining the value of at least one initial hand before all of the initial hands have been dealt includes evaluating the value according to a set of rules for the card game.
